(19) United States
(12) Patent Application Publication
(10) Pub. No.: US 2009/0201551 A1
(43) Pub. Date: Aug. 13, 2009

(54) PRINTING APPARATUS, DOCUMENT MANAGEMENT APPARATUS, METHOD FOR CONTROLLING THE SAME, AND STORAGE MEDIUM STORING PROGRAM

(75) Inventor: Takayuki Uchida, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/368,751

(22) Filed: Feb. 10, 2009

(30) Foreign Application Priority Data
Feb. 12, 2008 (JP) 2008-031005

(51) Int. Cl. G06F 3/12

(52) U.S. Cl. 358/1.15

(57) ABSTRACT

A printing apparatus includes a first acquisition unit configured to acquire a print setting of document data from a document management apparatus, a determination unit configured to determine whether the document data can be printed using the print setting acquired by the first acquisition unit, an output unit configured to output information about a result determined by the determination unit to the document management apparatus, a second acquisition unit configured to acquire, from the document management apparatus, printing availability determination information about a determined result as to whether document data can be printed with the printing apparatus, a display unit configured to display the printing availability determination information acquired by the second acquisition unit and printing apparatus information on a display apparatus, a third acquisition unit configured to acquire document data designated by a user from the document management apparatus by requesting the document management apparatus to transmit the document data, and a printing unit configured to print the document data acquired by the third acquisition unit.

### BACKGROUND OF THE INVENTION

1. Field of the Invention

The present invention relates to a printing apparatus, a document management apparatus, a method, and a storage medium storing a computer program for controlling the printing apparatus and the document management apparatus, and more particularly, to a printing system for outputting document data to a printing apparatus according to a request from the printing apparatus and printing the document data on the printing apparatus.

2. Description of the Related Art

There is a printing system that uses an Extensible Markup Language (XML) paper specification (XPS) adopted in Windows® Vista operating system (OS). In such a printing system, an XML part that contains information about document structure, drawing information, and print setting and resource parts such as bit maps and fonts constitute print data, i.e., XPS data. Further, a print setting contained in XPS data is referred to as PrintTicket. A PrintTicket includes a public portion, in which a specification is disclosed, and a private portion, which is independently defined by each vendor.

Moreover, there is a pull printing system in which a user temporarily stores print data in a print server instead of directly designating a printer to output the print data when the user instructs printing from a client apparatus such as a computer. The user then instructs an arbitrary printer to acquire the print job stored in the print server, by operating an operation panel of the printer, which is used to output the print data, or an operation terminal near the printer. The printer thus acquires the designated print job from the print server and performs printing.

In a case where a pull printing is performed based on print data that includes a print setting, e.g., XPS data, the printer cannot recognize the print setting of the print data until the printer acquires the print data. Further, print data whose print setting is expanded in a private portion of the PrintTicket can be printed only by a printer that can interpret the PrintTicket. However, printers of a plurality of vendors are often installed in a printing environment of a user. Consequently, if pull printing is performed in such a printing environment, a user may receive an unexpected printing result.

To solve such a problem, there is a technique which determines whether print data can be printed before transmitting the print data to a printer by comparing a print setting included in the print data with the capability of the printer (refer to Japanese Patent Application Laid-Open No. 2006-139561). Further, there is a technique which searches for an appropriate printer to perform printing by comparing the capabilities of all printers with the print setting before instructing to print (refer to Japanese Patent Application Laid-Open No. 2001-282489).

However, if the technique discussed in Japanese Patent Application Laid-Open No. 2006-139561 is applied to pull printing, and if it is determined that the print data cannot be printed, a user is not notified of another printer that can print the print data. Consequently, the user is required to move onto another printer and repeat the comparison between the capability of the printer and the print setting.

Further, if the technique discussed in Japanese Patent Application Laid-Open No. 2001-282489 is applied to pull printing, it is necessary to search for a printer on each occasion of a print instruction, which is time consuming and is thus very inefficient.

Further, if it is determined that print data cannot be printed as a result of comparing the printer capability and the print setting, the user may operate an operation panel of the printer to change the printer setting to print the print data. In such a case, printing instructed by a different user may be performed under the changed setting, so that the print result of the different user is affected.

### SUMMARY OF THE INVENTION

The present invention is directed to allowing a user to easily determine, before printing, a printing apparatus that can print document data, when print data including a print setting is output to a printing apparatus to be printed according to a request from the printing apparatus. Further, the present invention is directed to allowing document data to be printed using a print setting appropriate for a user without affecting printing instructed by another user, when print data including a print setting is output to a printing apparatus to be printed according to a request from the printing apparatus.

According to an aspect of the present invention, a printing apparatus includes a first acquisition unit configured to acquire a print setting of document data from a document management apparatus, a determination unit configured to determine whether the document data can be printed using the print setting acquired by the first acquisition unit, an output unit configured to output information about a result determined by the determination unit to the document management apparatus, a second acquisition unit configured to acquire, from the document management apparatus, printing availability determination information about a determined result as to whether document data can be printed with the printing apparatus, a display unit configured to display the printing availability determination information acquired by the second acquisition unit and printing apparatus information on a display apparatus, a third acquisition unit configured to acquire document data designated by a user from the document management apparatus by requesting the document management apparatus to transmit the document data, and a printing unit configured to print the document data acquired by the third acquisition unit.

According to another aspect of the present invention, a document management apparatus includes a first output unit configured to output a print setting of document data to a printing apparatus, an acquisition unit configured to acquire from the printing apparatus information about whether the document data can be printed using the print setting output from the first output unit, an updating unit configured to update information about a print setting of the document data using the information acquired by the acquisition unit, and a second output unit configured to output document data requested by the printing apparatus to the printing apparatus, wherein the second output unit outputs the document data, in which information about the print setting is updated, to the printing apparatus when the information about the print setting of the document data requested by the printing apparatus is updated by the updating unit.

According to yet another aspect of the present invention, a print control method includes acquiring a print setting of document data from a document management apparatus, determining whether the document data can be printed using the acquired print setting, outputting information about the determined result to the document management apparatus, acquiring printing availability determination information about a determined result as to whether document data can be printed with a printing apparatus from the document management apparatus, displaying the acquired printing availability determination information and printing apparatus information on a display apparatus, acquiring document data designated by a user from the document management apparatus by requesting the document management apparatus to transmit the document data, and printing the acquired document data.

According to yet another aspect of the present invention, a document management method includes outputting a print setting of document data to a printing apparatus, acquiring from the printing apparatus information about whether the document data can be printed using the output print setting, updating information about a print setting of the document data using the acquired information, outputting the document data requested by the printing apparatus to the printing apparatus, and outputting the document data in which print setting information is updated to the printing apparatus when the print setting information of the document data requested by the printing apparatus is updated.

According to yet another aspect of the present invention, a computer-readable storage medium stores a computer program that causes a computer to execute a print control method includes acquiring a print setting of document data from a document management apparatus, determining whether the document data can be printed using the acquired print setting, outputting information about the determined result to the document management apparatus, acquiring printing availability determination information about a determined result as to whether the document data can be printed with a printing apparatus from the document management apparatus, displaying the acquired printing availability determination information and printing apparatus information on a display apparatus, acquiring document data designated by a user from the document management apparatus by requesting the document management apparatus to acquire the document data, and printing the acquired document data.

According to yet another aspect of the present invention, a computer-readable storage medium stores a computer program that causes a computer to execute a document management method includes outputting a print setting of document data to a printing apparatus, acquiring from the printing apparatus information about whether the document data can be printed using the output print setting, updating information about a print setting of the document data using the acquired information, outputting document data requested by the printing apparatus to the printing apparatus, and outputting document data in which a print setting information is updated to the printing apparatus when the print setting information of document data requested by the printing apparatus is updated.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of an overall configuration of a print system according to a first exemplary embodiment of the present invention.

FIG. 2 is a block diagram illustrating an example of a hardware configuration of a client apparatus and a print server according to the first exemplary embodiment of the present invention.

FIG. 3 is a block diagram illustrating an example of a functional configuration of a printing apparatus according to the first exemplary embodiment of the present invention.

FIG. 4A is a block diagram illustrating an example of a functional configuration of a print server according to the first exemplary embodiment of the present invention.

FIG. 4B illustrates an example of print document information stored in a document storage unit according to the first exemplary embodiment of the present invention.

FIG. 5 illustrates an example of a print document list operation screen displayed on a panel of a printing apparatus according to the first exemplary embodiment of the present invention.

FIG. 6 is a flowchart illustrating an example of a process performed by a printing apparatus according to the first exemplary embodiment of the present invention.

FIG. 7 is a flowchart illustrating an example of a process performed by a print server according to the first exemplary embodiment of the present invention.

FIGS. 8A, 8B, and 8C illustrate examples of print document information after print setting information is updated according to the first exemplary embodiment of the present invention.

FIG. 9 illustrates a schematic diagram of an example of main parts included in XPS according to a second exemplary embodiment of the present invention.

FIG. 10 illustrates a schematic diagram of an example of a print document based on XPS (XPS document) according to the second exemplary embodiment of the present invention.

FIG. 11 illustrates an example of a content of a relationship file according to the second exemplary embodiment of the present invention.

FIG. 12 is a block diagram illustrating an example of a functional configuration of a printing apparatus according to the second exemplary embodiment of the present invention.

FIG. 13 is a flowchart illustrating an example of a process performed by a printing apparatus according to the second exemplary embodiment of the present invention.

FIG. 14 is a flowchart illustrating an example of details of a print setting changing process illustrated in FIG. 13 according to the second exemplary embodiment of the present invention.

FIG. 15 is a flowchart illustrating an example of a process performed by a print server when a print setting changing process is performed by a printing apparatus according to the second exemplary embodiment of the present invention.

FIGS. 16A and 16B are schematic diagrams illustrating an example of a print document updated by a process illustrated in FIG. 15 according to the second exemplary embodiment of the present invention.

FIG. 17 is a flowchart illustrating an example of a process performed by a print server when transmission of print data is requested after a print setting changing process has been executed according to the second exemplary embodiment of the present invention.

FIG. 18 illustrates an example of a content of a relationship file before and after a Target attribute of a Relationship element has been changed according to the second exemplary embodiment of the present invention.

FIG. 19 is a flowchart illustrating an example of a process performed by a print server when updating print document information (print setting information) according to a third exemplary embodiment of the present invention.

FIG. 20 is a flowchart illustrating an example of a process performed by a printing apparatus according to a fourth exemplary embodiment of the present invention.

### DETAILED DESCRIPTION OF THE EMBODIMENTS

Various exemplary embodiments, features, and aspects of the invention will be described in detail below with reference to the drawings.

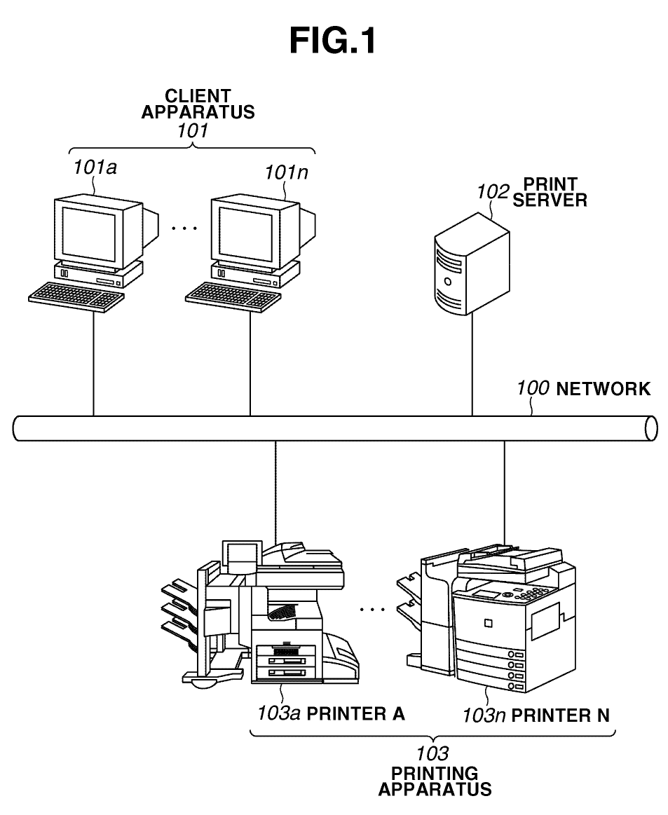

FIG. 1 illustrates an example of an overall configuration of a print system according to a first exemplary embodiment of the present invention.

Referring to FIG. 1, the print system includes a client apparatus 101 (for example, 101a to 101n), a print server 102, and a printing apparatus 103 (for example, 103a to 103n) that are interconnected via a network 100.

The client apparatus 101 is a general information terminal device including a network connection unit. When printing is instructed based on an execution of an application program installed in the client apparatus 101, a print job including print data such as XPS data is generated according to the execution of the application program. The client apparatus 101 then transmits the generated print job to the print server 102 via the network 100, and the print job is stored in the print server 102.

The print server 102 stores an executable print control program. The print server 102 controls the printing apparatus 103 included in the print system, stores files to be used on the network 100, and monitors usage status of the network 100.

The printing apparatus 103 can receive print data from the print server 102 via the network 100. An example of the printing apparatus 103 is a multifunction peripheral (MFP).

When the printing apparatus 103 requests the print server 102 to transmit print data, the print server 102 performs a user authentication process. More specifically, the print server 102 receives authentication information input by a user in the printing apparatus 103. The print server 102 further receives user information stored in a directory server (not illustrated) via the network 100. The print server 102 then performs the authentication process using the authentication information received from the printing apparatus 103 and the user information received from the directory server.

The print server 102 can include the directory server. Further, the print server 102 can be included in a particular printing apparatus 103. Further, the printing apparatus 103 can be a single function peripheral (SFP) such as a laser beam printer (LBP), and functions of the printing apparatus 103 described below can be included in the SFP.

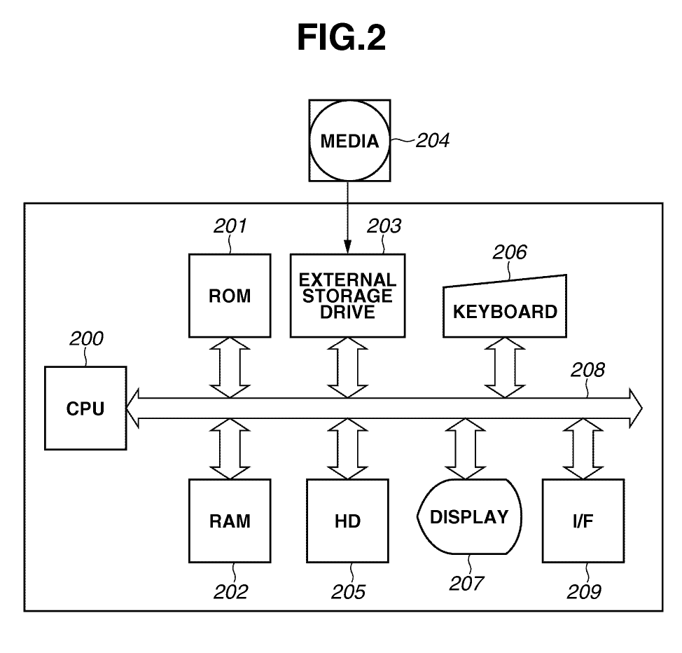

FIG. 2 is a block diagram illustrating a hardware configuration of the client apparatus 101 and the print server 102.

Referring to FIG. 2, a central processing unit (CPU) 200 executes programs stored in a hard disk (HD) 205. The CPU 200 further performs control to store information and files needed for an execution of a program temporarily in a random access memory (RAM) 202. The HD 205 stores programs such as an application program, a printer driver program, an operating system (OS) program, a network printer control program, and related programs.

A read-only memory (ROM) 201 stores programs such as a basic input/output (I/O) program, and various data such as a font data used for document processing and a template data.

The RAM 202 is a main memory or a work area of the CPU 200.

An external storage drive 203 loads a program stored in a media 204 onto the computer system.

The media 204 stores programs that execute at least a part of a process described below, and related data.

As described above, the HD 205 stores an application program, a printer driver program, an OS, a control program, and related programs. The HD 205 can store programs and related data output from the media 204.

A keyboard 206 is a user interface. A user uses the keyboard 206 or a mouse (not illustrated) on the client apparatus 101 to input an instruction such as a control command of the printing apparatus 103.

A display 207 such as a liquid crystal display (LCD) displays a command input from the keyboard 206 or the status of the printing apparatus 103.

A system bus 208 interconnects each apparatus in the computer system to be capable of communicating with each other. The system bus 208 thus controls the data flow in the computer system.

A network interface (I/F) 209 is a communication interface for connecting to the network 100 such as a local area network (LAN) or the Internet.

An example of a functional configuration of the printing apparatus 103 and the print server 102, and a flow of a pull-printing process will be described below.

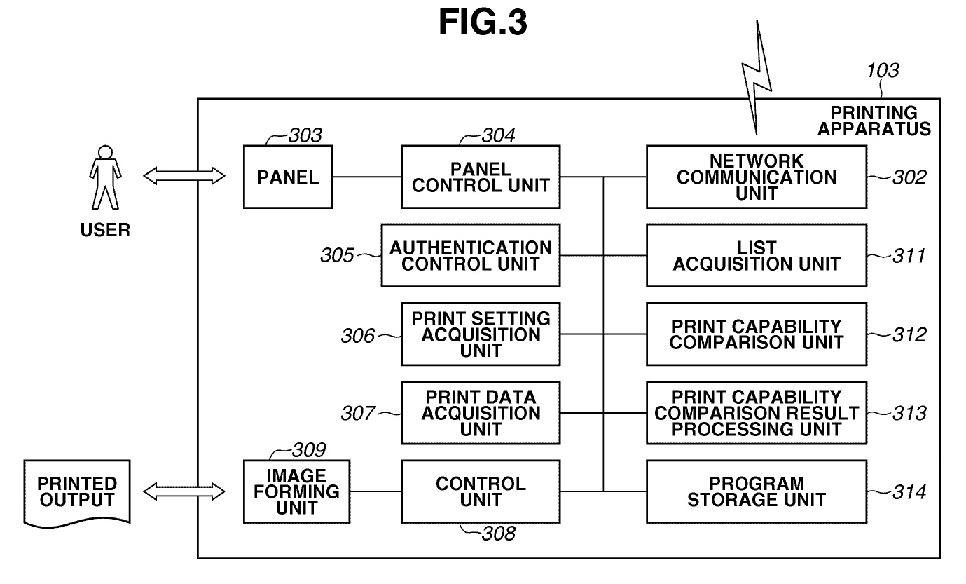

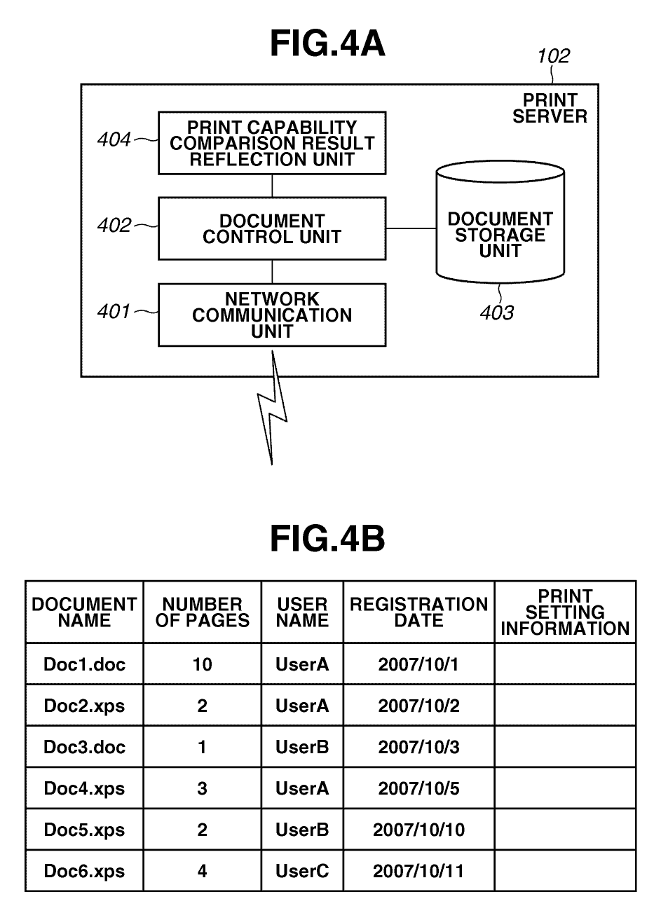

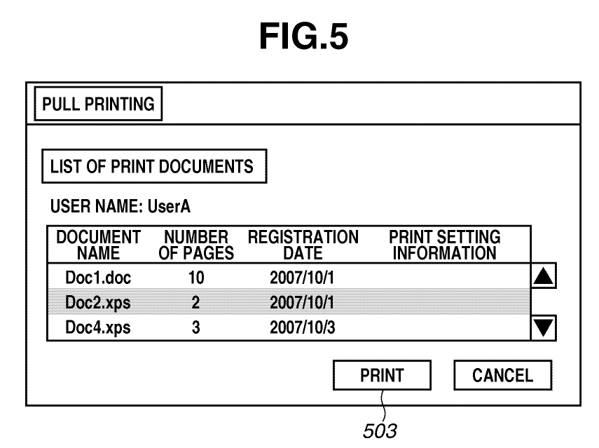

FIG. 3 is a block diagram of an example of a functional configuration of the printing apparatus 103. FIG. 4A is a block diagram illustrating an example of a functional configuration of the print server 102.

Referring to FIG. 4A, when a document control unit 402 of the print server 102 acquires a print job received by a network communication unit 401, the document control unit 402 registers the print document in a document storage unit 403. The document control unit 402 controls processes performed by each of the units when receiving a request to register a print document.

FIG. 4B illustrates an example of print document information stored in the document storage unit 403.

Further, the document control unit 402 performs a user authentication process based on authentication information received by the network communication unit 401 from the printing apparatus 103 and user information stored in the directory server. If the user authentication is successful, the document control unit 402 transmits to the printing apparatus 103 a list of print documents that the user can print based on the authentication information received from the printing apparatus 103. The document control unit 402 further transmits to the printing apparatus 103 a print document designated by the user using a panel 303 of the printing apparatus 103.

Referring to FIG. 3, an authentication control unit 305 of the printing apparatus 103 transmits to the print server 102 authentication information (identification, i.e., ID) input by the user using the panel 303 or an Integrated Circuit (IC) card reader (not illustrated). The authentication control unit 305 transmits authentication information to the print server 102 via network communication unit 302.

After the print server 102 performs an authentication process, a list acquisition processing unit 311 acquires a list of print documents that the user can print from the print server 102 and displays the list on the panel 303. Consequently, the user selects a document to be printed using the panel 303.

A control unit 308 then acquires the selected print document from the print server 102 and rasterizes the acquired print document into a raster image.

An image forming unit 309 forms an image based on the raster image on a recording paper (i.e., a printing process).

The present exemplary embodiment describes an example in which the print server 102 performs the authentication process. However, the present invention is not limited to the above-described method, and, for example, the printing apparatus 103 can perform the user authentication process.

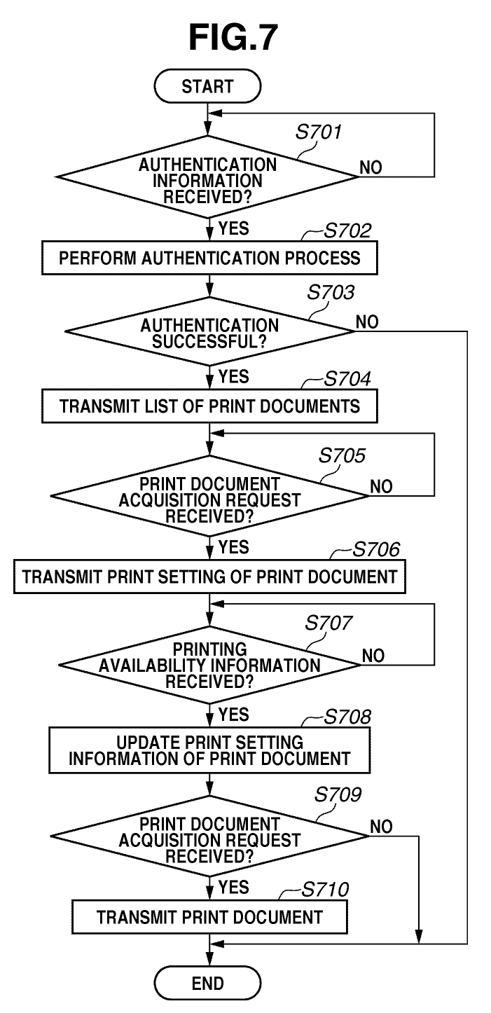

Further, since the authentication process using a panel or an IC card is a known technology, a detailed description thereof is omitted. Details of an operation of the printing apparatus 103 illustrated in FIG. 3 and other units will be described below referring to FIG. 6.

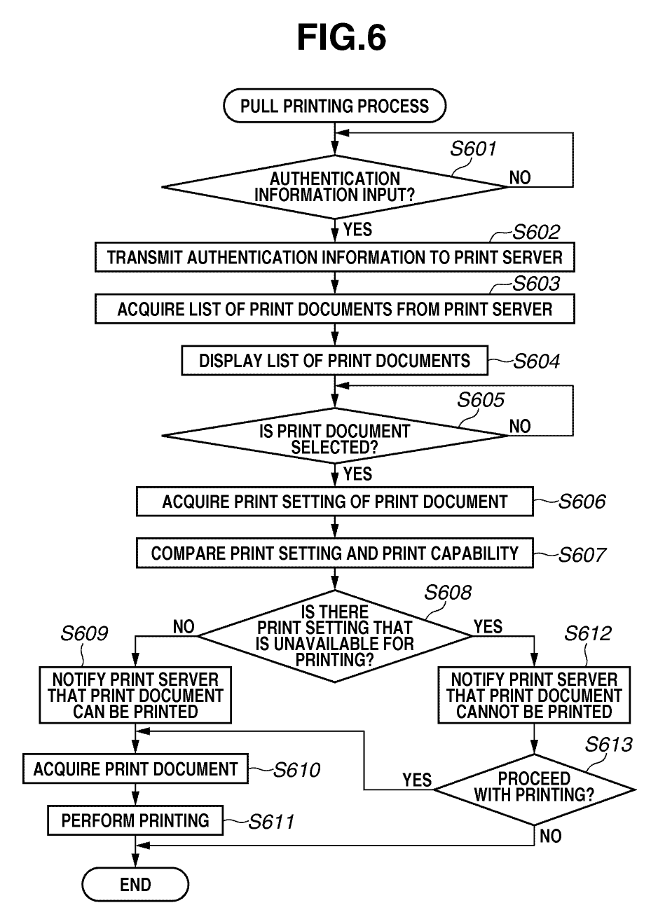

FIG. 5 illustrates an example of a print document list operation screen displayed on the panel 303 of the printing apparatus 103.

Referring to FIG. 5, after a “User A” is authenticated, a list of print documents that the “User A” previously instructed the printing server 102 to register is displayed on the panel 303. If the “User A” selects a document “Doc2.xps” and presses a print button 503, the printing apparatus 103 acquires the printing document “Doc2.xps” from the print server 102 and performs printing.

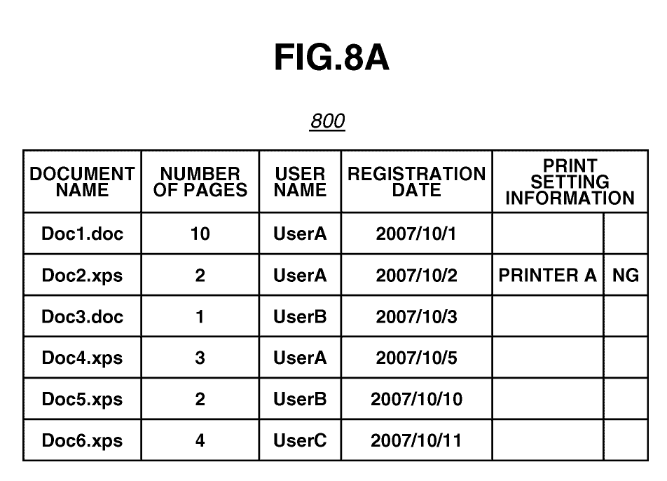

An example of a process performed by the printing apparatus 103 and the print server 102 according to the present exemplary embodiment will be described below with reference to flowcharts illustrated in FIGS. 6 and 7. FIG. 6 is a flowchart illustrating an example of a process performed by the printing apparatus 103. FIG. 7 is a flowchart illustrating an example of a process performed by the print server 102.

A program of the printing apparatus 103 for executing the process illustrated in FIG. 6 is stored in a program storage unit 314 such as a HD drive (HDD). The control unit 308 reads out the program stored in the program storage unit 314 to the RAM (not illustrated) and executes the program.

Further, a program of the print server 102 for executing the process illustrated in FIG. 7 is stored in the HD 205. The CPU 200 reads out the program stored in the HD 205 and executes the program.

In step S601 of the flowchart illustrated in FIG. 6, the authentication control unit 305 in the printing apparatus 103 stands by until a user inputs authentication information (ID) via the panel 303 of the printing apparatus 103 (hereinafter, the printing apparatus 103 will be referred to as printer A as necessary, to identify from other printing apparatus 103). If the user inputs authentication information (YES in step S601), the processing proceeds to step S602.

In step S602, the network communication unit 302 transmits the input authentication information to the print server 102.

In step S603, if the user authentication is successful in the print server 102, the list acquisition unit 311 acquires from the print server 102 a list of print documents that can be printed by the user whose authentication is successful.

In a case where the printing apparatus 103 performs the user authentication, the authentication control unit 305 performs the authentication process based on the authentication information input by the user via the panel 303. If the user authentication is successful, the list acquisition unit 311 requests the print server 102 for a list of print documents that can be printed by the user and acquires the list.

In step S701 illustrated in FIG. 7, the network communication unit 401 of the print server 102 stands by until authentication information is received from the printing apparatus 103.

In step S702, after receiving the authentication information, the document control unit 402 performs the user authentication process based on the authentication information received in step S701 and user information stored in the directory server.

In step S703, the document control unit 402 determines whether the user authentication is successful based on the result of the authentication processing performed in step S702. If the user authentication fails (NO in step S703), the user is not permitted to print, and the processing illustrated in FIG. 7 ends. On the other hand, if the user authentication is successful (YES in step S703), the processing proceeds to step S704.

In step S704, the document control unit 402 acquires from the document storage unit 403 a list of print documents that the user can print, based on the authentication information received from the printing apparatus 103. The document control unit 402 then transmits the list to the printing apparatus 103.

In step S604 illustrated in FIG. 6, the panel control unit 304 of the printing apparatus 103 displays on the panel 303 the acquired list of print documents that the user can print.

In step S605, the panel control unit 304 stands by until the print document to be printed is selected by the user using the panel 303. If the user selects a print document (YES in step S605), the processing proceeds to step S606.

In step S606, the print setting acquisition processing unit 306 requests the print server 102 to transmit a print setting of the print document selected by the user and acquires the transmitted print setting via the network communication unit 302. As described above, according to the present exemplary embodiment, an example of a first acquisition unit of a printing apparatus is realized by performing the process of step S606.

In step S705 illustrated in FIG. 7, after the network communication unit 401 of the print server 102 receives the request to transmit the print setting of the print document from the printing apparatus 103 (YES in step S705), the processing proceeds to step S706.

In step S706, the document control unit 402 acquires the print setting of the print document selected by the user from the document storage unit 403. The network communication unit 401 then transmits the acquired print setting to the printing apparatus 103. As described above, according to the present exemplary embodiment, an example of a first output unit of a document management apparatus is realized by performing the processing in step S706.

In step S607 illustrated in FIG. 6, a print capability comparison unit 312 of the printing apparatus 103 then compares the acquired print setting with print capability information of the printer A itself.

In step S608, the print capability comparison unit 312 determines whether there is a setting in the acquired print setting that is not available for printing by the printer A, based on the result of comparison performed in step S607. As described above, according to the present exemplary embodiment, an example of a determination unit of a printing apparatus is realized by performing the processing in step S608. If there is no setting in the print setting that is not available for printing by the printer A (NO in step S608), the processing proceeds to step S609.

In step S609, a print capability comparison result processing unit 313 notifies the print server 102 via the network communication unit 302 of printing availability information indicating that the print document selected by the user can be printed by the printer A. As described above, according to the present exemplary embodiment, an example of an output unit of a printing apparatus is realized by performing the process in step S609.

In step S707 illustrated in FIG. 7, the network communication unit 401 of the print server 102 stands by until the printing availability information indicating that the print document selected by the user can be printed by the printer A transmitted by the printing apparatus 103 in step S609 is received. Upon the network communication unit 401 receiving the printing availability information (YES in step S707), the processing proceeds to step S708.

In step S708, the document control unit 402 updates the print document information (i.e., print setting information, refer to FIG. 4B) stored in the document storage unit 403, according to a content of the printing availability information. More specifically, the document control unit 402 updates the print setting information by writing information in the document storage unit 403 indicating that the print document selected by the user can be printed by the printer A. Further, if a result of comparing the print setting of the print document selected by the user with the print capability of the printer A is to be reflected in the document storage unit 403, the document control unit 402 updates the document storage unit 403 according to a process performed by a print capability comparison result reflection unit 404.

As described above, according to the present exemplary embodiment, an example of an acquisition unit of a document management apparatus is realized by performing the process in step S707. Further, an example of an updating unit of a document management apparatus is realized by performing the process in step S708.

In step S610 illustrated in FIG. 6, the print data acquisition unit 307 of the printing apparatus 103 requests the print server 102 to transmit the print document data (print data). As described above, according to the present exemplary embodiment, an example of document data is realized by print document data and a third acquisition unit of a printing apparatus is realized by performing the process in step S610.

In step S709 illustrated in FIG. 7, if the network communication unit 401 of the print server 102 receives a request to transmit the print data (YES in step S709), the processing then proceeds to step S710.

In step S710, the document control unit 402 acquires the data of the print document selected by the user from the document storage unit 403. The network communication unit 401 then transmits the acquired print document data to the printing apparatus 103. As described above, according to the present exemplary embodiment, a second output unit of a document management apparatus is realized by performing the process in step S710.

In step S611 illustrated in FIG. 6, when the network communication unit 302 of the printing apparatus 103 receives the data of the print document selected by the user, the image forming unit 309 performs printing according to the print document data. The processing illustrated in FIG. 6 then ends. As described above, according to the present exemplary embodiment, an example of a printing unit of a printing apparatus is realized by performing the process in step S611.

On the other hand, if it is determined in step S608 illustrated in FIG. 6 that there is a setting in the print settings, acquired from the print server 102, that is not available for printing by the printer A (YES in step S608), the processing proceeds to step S612.

In step S612, the print capability comparison result processing unit 313 notifies, via the network communication unit 302, the print server 102 of print availability information indicating that the print document selected by the user cannot be printed by the printer A. As described above, according to the present exemplary embodiment, an example of an output unit of a printing apparatus is realized by performing the process in step S612.

If the printing availability information is received by the network communication unit 401 of the print server 102 (YES in step S707 illustrated in FIG. 7), the processing proceeds to step S708. In step S708, the document control unit 402 writes the content of the received printing availability information in the document storage unit 403 and updates the print setting information.

In step S613 illustrated in FIG. 6, the panel control unit 304 of the printing apparatus 103 displays a confirmation screen (not illustrated) on the panel 303. The print data acquisition unit 307 then determines whether to continue printing according to a user operation on the confirmation screen. If printing is not to be continued (NO in step S613), the processing illustrated in FIG. 6 ends. On the other hand, if the printing is to be continued (YES in step S613), the processing proceeds to step S610. In step S610, the print data acquisition unit 307 requests the print server 102 to transmit the data of the print document (print data) as described above.

A case where a user instructs the printing apparatus 103 to perform pull printing after the print document information (print setting information) is updated by performing the above-described process will be described below. The pull printing can be instructed to the printer apparatus 103 other than the printer A.

In step S603 illustrated in FIG. 6, the list acquisition unit 311 of the printing apparatus 103 acquires from the print server 102 a list of print documents in which print setting information have been updated by the process performed in step S708.

In step S604, the panel control unit 304 displays a list of print documents on the panel 303. As described above, according to the present exemplary embodiment, an example of printing availability determination information is realized by print setting information. Further, an example of a second acquisition unit of a printing apparatus is realized by performing the process in step S603, and an example of a display unit of a printing apparatus is realized by performing the process in step S604.

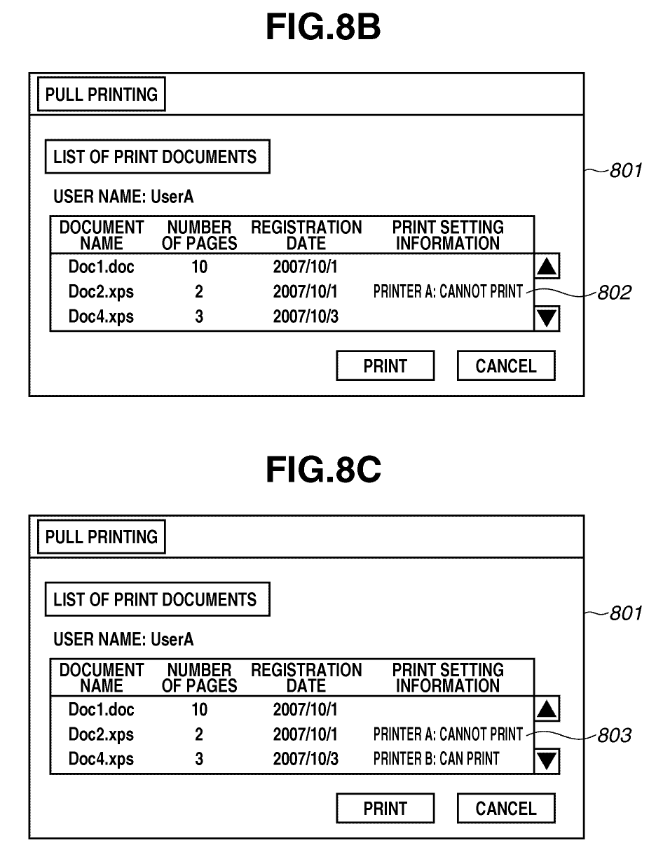

FIG. 8A illustrates an example of print document information after the print setting information is updated.

Referring to FIG. 8A, an example of print document information 800 is illustrated, in which print setting information is updated, in step S612 as illustrated in FIG. 6, to indicate that a print document “Doc2.xps” cannot be printed by the printer A. As described above, the print document information is stored in the document storage unit 403.

FIGS. 8B and 8C illustrate first and second examples of a print documents list operation screen displayed on the panel 303 of the printing apparatus 103 when a user instructs pull printing to be performed after the print setting information is updated.

Referring to FIG. 8B, a user can easily recognize that the document “Doc2.xps” cannot be printed by the printer A from a list item 802 of an operation screen 801. Further, referring to FIG. 8C, a user can easily recognize that a document “Doc4.xps” can be printed by a printer B from a list item 803. As described above, the printing apparatus 103 to which the user instructs an execution of pull printing after the print setting information is updated can be a printing apparatus 103 other than the printer A.

As described above, according to the present exemplary embodiment, the print server 102 stores print settings of print documents. When the user instructs the printing apparatus 103 to print a print document selected by the user on the printing apparatus 103, the print setting of the print document is compared with the print capability of the printing apparatus 103. The printing apparatus 103 determines whether the selected print document can be printed and reflects the determination result in the print document information stored in the print server 102.

When the user performs a predetermined operation on the printing apparatus 103, the printing apparatus 103 acquires information about print documents previously registered by the user from the print server 102. The printing apparatus 103 then displays print setting information indicating which printing apparatus 103 can print the print documents registered by the user and which printing apparatus 103 cannot print the print documents, based on the acquired information, together with information on the printing apparatus 103, as information about print documents registered by the user. As a result, the user can easily determine which printing apparatus 103 can print the print data before printing the print data in a pull printing environment.

The present exemplary embodiment describes a case where a print document is temporarily stored in the print server 102 when the application in the client apparatus 101 instructs printing. However, the present invention is not limited to the above-described method. For example, a user can store an arbitrary print document in the file server instead of the print server 102. If a file server is to be used, a result of a pull printing process described in the present exemplary embodiment is stored in a specific directory. Consequently, in a case where the printing apparatus 103 requests pull printing, a reference can be made to the result of the pull printing process (printing availability information) stored in the specific directory.

Further, in the present exemplary embodiment, when a user operates on the panel 303 and selects a print document, the printing apparatus 103 acquires the print setting from the print server 102 and compares the print setting with the print capability. The printing apparatus 103 then acquires the print document. However, the present invention is not limited to the above-described method. For example, the printing apparatus 103 can acquire the print document together with the print setting when the user selects the print document.

Further, in the present exemplary embodiment, the printing apparatus 103 compares the print setting with the print capability. However, the present invention is not limited to such a method. For example, the printing apparatus 103 can transmit the print capability information to the print server 102, and the print server 102 can make a comparison between the print setting and the print capability.

There are some companies that basically prohibit color printing, and a printing environment is created in which color printing can only be performed when there is an approval by a person in charge such as a general manager. Therefore, a user cannot print a print document with a color setting if the user performs pull printing of the document on a color printing apparatus before receiving the approval.

In such a case, a user who wishes to print the print document in monochrome instead of color may operate the panel of the printing apparatus and change the color setting to a monochrome setting and cause the printing apparatus to print. However, since changing the print setting may affect the print result of the next user who performs pull printing, it is not favorable to change the print setting of the printing apparatus.

In a second exemplary embodiment of the present invention, the print setting of the printing apparatus is temporarily changed when printing cannot be performed as a result of comparing the print setting of a print document, which is selected by a user, with the print capability. The changed print setting is then added to the print setting of the print document in the print server, and printing is thus continued using the added print setting.

As described above, the second exemplary embodiment is different from the first exemplary embodiment mainly in a process performed when a print document selected by a user cannot be printed as a result of comparing the print setting of the print document with the print capability. Therefore, in the second exemplary embodiment, portions that are similar to the first exemplary embodiment will be assigned the same reference numerals as in FIGS. 1 to 8, and a detailed description is not repeated.

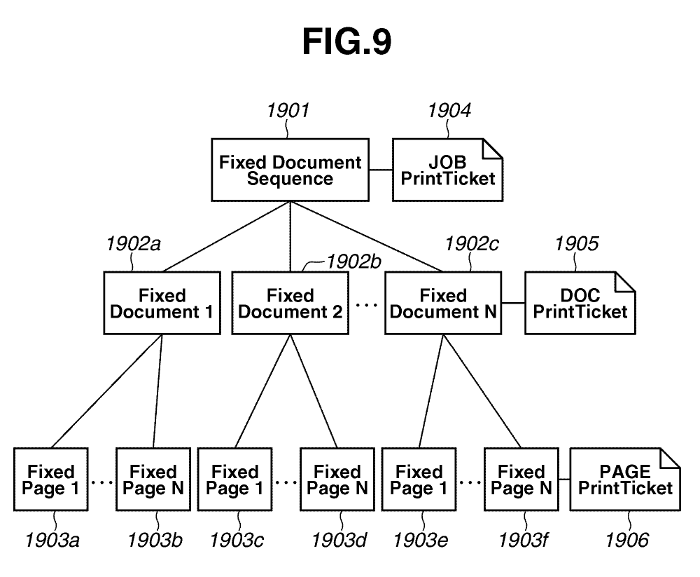

FIG. 9 illustrates a schematic diagram of the main parts of the XPS.

Referring to FIG. 9, a print setting can be associated with each of an arbitrary FixedDocumentSequence part 1901, FixedDocument part 1902a to 1902c, and FixedPage part 1903a to 1903f. More specifically, a PrintTicket 1904 associated with the FixedDocumentSequence part 1901 defines a print setting of a print job. Further, a PrintTicket 1905 associated with the FixedDocument part 1902 defines a print setting of a print document. Further, a PrintTicket 1906 associated with the FixedPage part 1903 defines a print setting of a page.

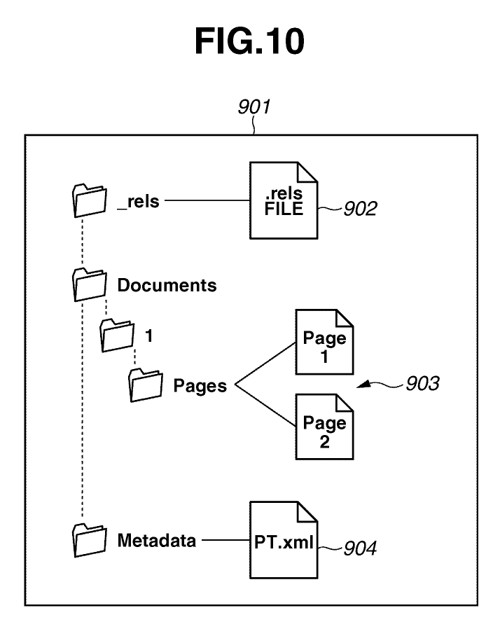

FIG. 10 illustrates a schematic diagram of an example of a print document based on XPS (XPS document). A print setting of a print job will be mainly described below with reference to FIG. 10.

An XPS document 901, as an example of a print document, includes page drawing data 903, which is drawing data for each page, and a PrintTicket 904, which is a print setting of the print job. The XPS document further includes a relationship file 902 that describes a relationship between the page drawing data 903 and the PrintTicket 904. The example of the print document illustrated in FIG. 10 includes two pages.

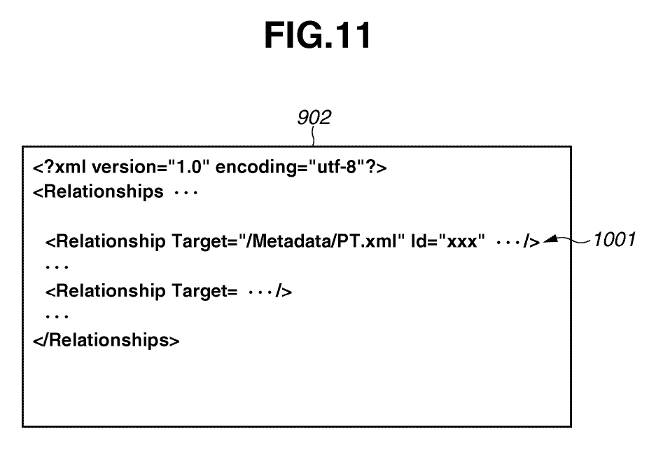

FIG. 11 illustrates an example of the relationship file 902.

Referring to FIG. 11, a Target attribute 1001 of a Relationship element indicates that a print setting “PT.xml” is applied to the XPS document 901.

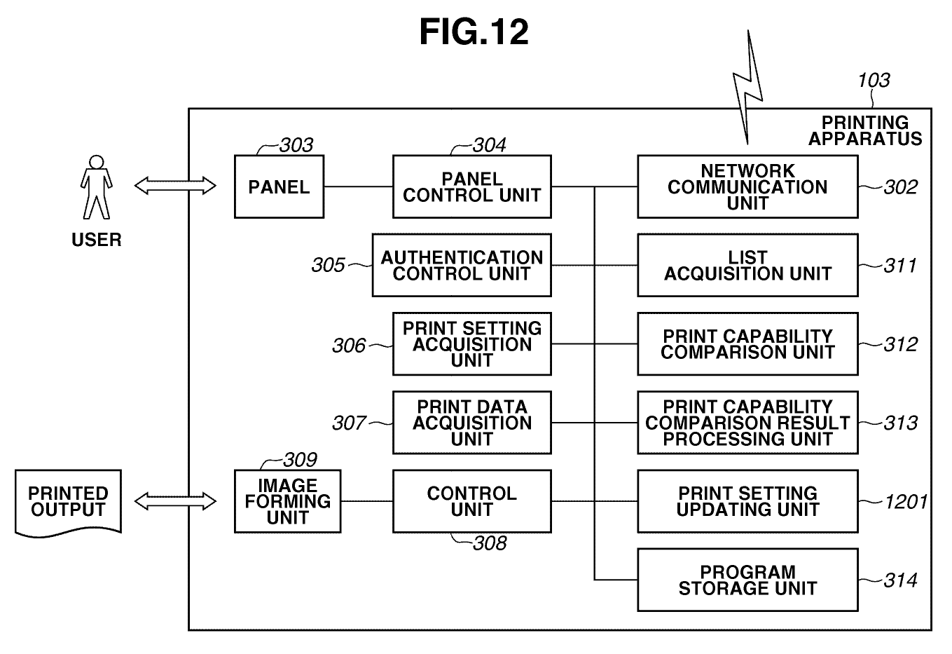

FIG. 12 is a block diagram illustrating an example of a functional configuration of the printing apparatus 103 according to the present exemplary embodiment.

Referring to FIG. 12, in the printing apparatus 103 according to the second exemplary embodiment, a print setting updating unit 1201 is added to the printing apparatus 103 described in the first exemplary embodiment illustrated in FIG. 3.

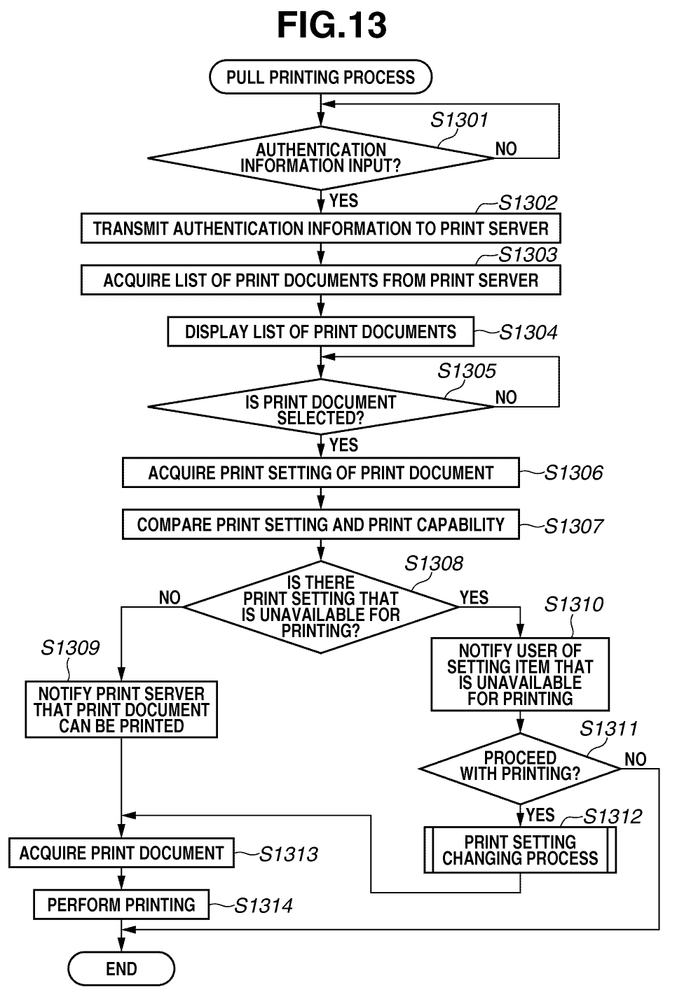

An example of a process performed by the printing apparatus 103 and the print server 102 according to the present exemplary embodiment will be described below with reference to flowcharts illustrated in FIG. 13 and FIG. 7. FIG. 13 is a flowchart illustrating an example of a process performed by the printing apparatus 103. FIG. 7 is a flowchart illustrating an example of a process performed by the print server 102 as described above.

In step S1301, the authentication control unit 305 of the printing apparatus 103 determines whether the user has input authentication information (ID) via the panel 303 of the printing apparatus 103. If the user inputs the authentication information (YES instep S1301), the processing proceeds to step S1302. In step S1302, the network communication unit 302 transmits the authentication information to the print server 102. The printing apparatus 103 will be referred to as a printer A as necessary, similarly as in the first exemplary embodiment.

In step S1303, if the user authentication process performed by the print server 102 is successful, the list acquisition unit 311 acquires from the print server 102 a list of print documents that can be printed by the user whose authentication is successful.

On the other hand, in step S701 illustrated in FIG. 7, the network communication unit 401 of the print server 102 determines whether authentication information is received from the printing apparatus 103. If the authentication information is received (YES in step S701), the processing proceeds to step S702. In step S702, the document control unit 402 performs a user authentication process using the authentication information.

In step S703, the document control unit 402 determines whether the user authentication is successful. If the user authentication is successful (YES in step S703), the processing proceeds to step S704. In step S704, the document control unit 402 acquires a list of print documents that can be printed by the user and transmits the list to the printing apparatus 103.

In step S1304 illustrated in FIG. 13, the panel control unit 304 of the printing apparatus 103 acquires the list of print documents that can be printed by the user and displays the list on the panel 303.

In step S1305, the panel control unit 304 stands by until the user selects the print document. When the user selects the print document (YES in step S1305), the processing proceeds to step S1306.

In step S1306, the print setting acquisition unit 306 requests the print server 102 to transmit a print setting of the selected print document.

In step S705 illustrated in FIG. 7, the network communication unit 401 of the print server 102 receives the request to transmit the print setting of the selected print document (YES in S705). Then, the processing proceeds to step S706.

In step S706, the document control unit 402 acquires the print setting of the selected print document from the document storage unit 403. The network communication unit 401 then transmits the acquired print setting to the printing apparatus 103.

As described above, according to the present exemplary embodiment, an example of a first acquisition unit of a printing apparatus is realized by performing the process of step S1306. Further, an example of a first output unit of a document management apparatus is realized by performing the process of step S706.

In step S1307 illustrated in FIG. 13, the print capability comparison unit 312 of the printing apparatus 103 then compares the print setting acquired by the print setting acquisition unit 306 and the print capability information of the printer A itself.

In step S1308, the print capability comparison unit 312 then determines whether there is a print setting that is not available for printing by the printer A. According to the present exemplary embodiment, an example of a determination unit of a printing apparatus is realized by performing the process of step S1308.

If it is determined that there is no print setting that is not available for printing by the printer A (NO in step S1308), the processing proceeds to step S1309. As described above, according to the present exemplary embodiment, an example of an output unit of a printing apparatus is realized by performing the process of step S1309.

In step S708 illustrated in FIG. 7, the network communication unit 401 of the print server 102 then receives the printing availability information indicating that the print document selected by the user can be printed by the printer A (YES in step S707). The network control unit 402 then updates the print setting information in the print document information. More specifically, information indicating that the print document selected by the user can be printed by the printer A is set in the print setting information. The print document information is stored in the document storage unit 403 (refer to the description of FIG. 4B). As described above, according to the present exemplary embodiment, an example of an updating unit of a document management apparatus is realized by performing the process of step S708.

In step S1313 illustrated in FIG. 13, the print data acquisition unit 307 of the printing apparatus 103 requests the print server 102 to transmit the print document data (print data). In step S710 illustrated in FIG. 7, the document control unit 402 of the print server 102 acquires the print document selected by the user from the document storage unit 403 and transmits the document to the printing apparatus 103 via the network communication unit 401. As described above, according to the present exemplary embodiment, an example of a third acquisition unit of a printing apparatus is realized by performing the process of step S1313. Further, an example of a second output unit of a document management apparatus is realized by performing the process of step S710.

In step S1314, the network communication unit 302 of the printing apparatus 103 receives the data of the print document selected by the user, and the image forming unit 309 performs printing based on the data. The processing illustrated in FIG. 13 then ends.

On the other hand, in step S1308 illustrated in FIG. 13, if it is determined that there is a print setting in the print settings acquired from the print server 102 that is not available for printing by the printer A (YES in step S1308), the process proceeds to step S1310. For example, it is determined that there is a setting that cannot be printed by the printer A if a color setting is made to the print document selected by the user, and the print document cannot be printed because it is not approved.

In step S1310, the panel control unit 304 displays on the panel 303 a confirmation screen (not illustrated) including a print setting item that is not available for printing (such as the color setting in the above-described example) to notify it to the user.

In step S1311, the print data acquisition unit 307 determines whether to continue printing according to the user operation on the confirmation screen. If the print data acquisition unit 307 determines not to continue printing (NO in step S1311), the processing illustrated in FIG. 13 ends. On the other hand, if the print data acquisition unit 307 determines to continue printing (YES in step S1311), the processing proceeds to step S1312.

In step S1312, the print setting updating unit 1201 performs a print setting changing process to change the print setting of the print document selected by the user.

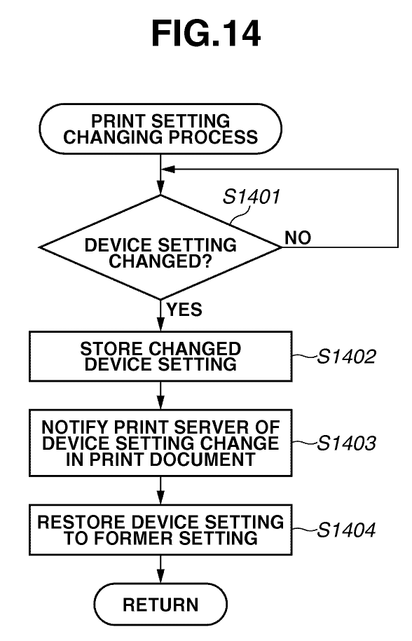

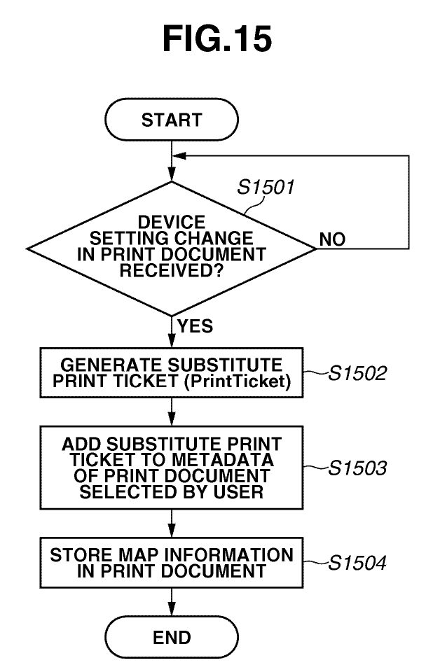

Details of the print setting changing process will be described below with reference to FIGS. 14 and 15.

FIG. 14 is a flowchart illustrating an example of details of the print setting changing process performed in step S1312 illustrated in FIG. 13. FIG. 15 is a flowchart illustrating an example of a process performed by the print server 102 when the printing apparatus 103 performs the print setting changing process.

In step S1401 illustrated in FIG. 14, the panel control unit 304 of the printing apparatus 103 stands by until the user operates on the panel 303 and changes a device setting in the print setting. For example, the user changes the color setting from “color” to “monochrome”.

In step S1402, after the user changes the device setting (YES in step S1401), the print setting updating unit 1201 stores the former device setting and the changed device setting. As described above, according to the present exemplary embodiment, an example of a first changing unit of a printing apparatus is realized by performing the processes of steps S1401 and S1402.

In step S1403, the print setting updating unit 1201 notifies the print server 102 via the network communication unit 302 of a user name, a document name of the print document selected by the user, and the changed print setting (device setting, e.g. the present value of the color setting).

In step S1404, the print setting updating unit 1201 then restores the changed device setting to the former device setting. As described above, according to the present exemplary embodiment, setting information is realized by the changed print setting, an example of document information is realized by the document name of the print document, and user information is realized by the user name. Further, an example of a second output unit of a printing apparatus is realized by performing the process of step S1403. Further, an example of a second changing unit of a printing apparatus is realized by performing the process of step S1404.

On the other hand, in step S1501 illustrated in FIG. 15, the network communication unit 401 of the print server 102 stands by until the user name, the document name of the print document selected by the user, and the changed print setting (device setting) are received. If the network communication unit 401 receives the above-described information (YES in step S1501), the processing proceeds to step S1502. As described above, according to the present exemplary embodiment, an example of a second acquisition unit of a document management apparatus is realized by performing the process of step S1501.

Instep S1502, the document control unit 402 generates a substitute PrintTicket based on the received changed print setting (device setting).

In step S1503, the document control unit 402 adds the substitute PrintTicket generated in step S1502 to a metadata of the print document selected by the user.

In step S1504, the document control unit 402 stores in the print document (e.g., in metadata) map information 1404 in which the user name, which is received in step S1501, and the file name of the substitute PrintTicket, which is added in step S1503, are paired. As described above, according to the present exemplary embodiment, an example of an adding unit of a document management apparatus is realized by performing the processes of steps S1502 to S1504.

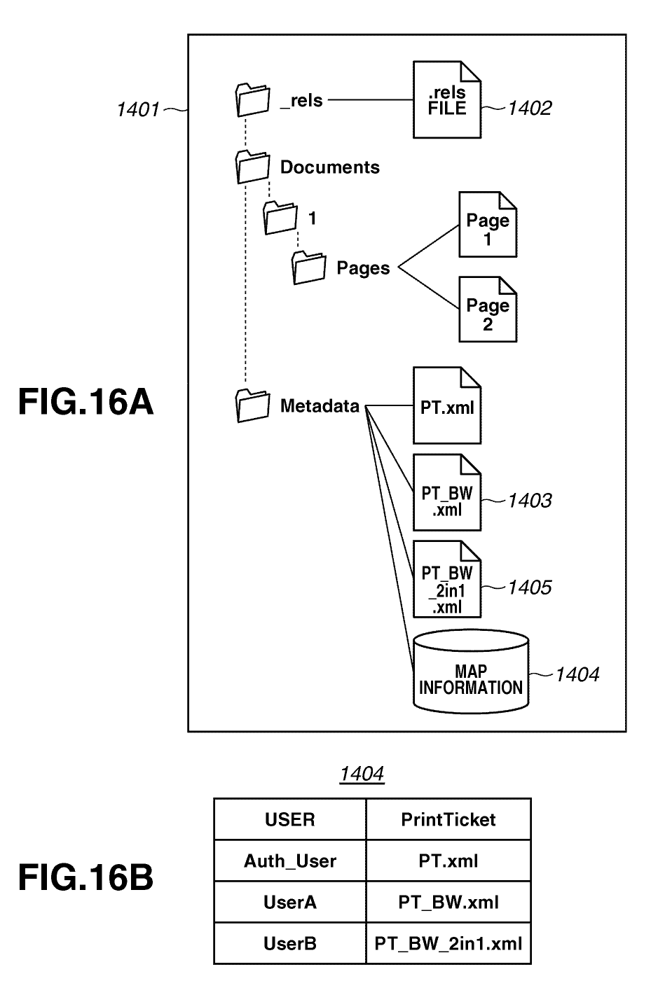

FIG. 16A illustrates a schematic diagram of an example of a print document which is updated by performing the processes of steps S1502 to S1504 illustrated in FIG. 15. In particular, FIG. 16A illustrates an example of a case where the print document is an XPS document.

Referring to FIG. 16A, a substitute PrintTicket “PT_BW.xml” 1403 and a substitute PrintTicket “PT_BW.2in1.xml” 1405 in which a color setting is set to “monochrome” are added to an XPS document 1401. Further, map information 1404, in which a user name “User A” and a file name of the substitute PrintTicket 1403 are paired, and a user name “User B” and a file name of the substitute PrintTicket 1405 are paired, is stored in the XPS document 1401.

FIG. 16B illustrates a schematic diagram of an example of the map information 1404. Referring to FIG. 16B, map information 1404, in which user names are associated with the file names of the substitute PrintTickets 1403 and 1405 used by users identified by the user names, is stored in the XPS document 1401.

Referring to FIG. 13, after the processing of step S1312 ends, the processing proceeds to step S1313. In step S1313, the print data acquisition unit 307 of the printing apparatus 103 requests the print server 102 to transmit the print document data (print data).

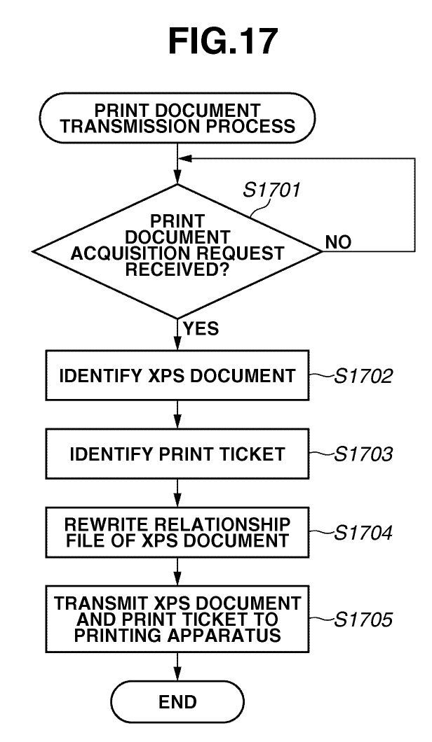

An example of a process performed by the print server 102 in a case where the printing apparatus 103 requests transmission of the print data after the print setting changing processing of step S1312 is performed will be described below. The process is described with reference to the flowchart illustrated in FIG. 17.

In step S1701, the document control unit 402 of the print server 102 stands by until the printing apparatus 103 requests transmission of the print document. If a request to transmit the print document is received (YES in step S1701), the processing proceeds to step S1702.

In step S1702, the document control unit 402 identifies the print document (XPS document 1401) to be transmitted to the printing apparatus 103 according to the document name of the print document received in step S1501 illustrated in FIG. 15.

In step S1703, the document control unit 402 identifies a PrintTicket to be transmitted to the printing apparatus 103 according to the map information 1404 stored in the XPS document 1401 identified in step S1702. The document control unit 402 identifies the PrintTicket based on the user name received in step S1501 illustrated in FIG. 15.

In step S1704, the document control unit 402 rewrites a Target attribute of a Relationship element in the relationship file 1402 of the identified XPS document 1401 to the name of the identified PrintTicket.

In step S1705, the network communication unit 401 of the print server 102 transmits the XPS document identified in step S1702 and the PrintTickets (substitute PrintTickets 1403 and 1405) identified in step S1703 to the printing apparatus 103. As described above, according to the present exemplary embodiment, an example of a second output unit of a document management apparatus is realized by performing the process of step S1705.

In step S1313 illustrated in FIG. 13, the network communication unit 302 of the printing apparatus 103 acquires the XPS document 1401 and the PrintTickets (substitute PrintTickets 1403 and 1405). In step S1314, the image forming unit 309 then performs the print process based on the received XPS document 1401 and the PrintTickets (substitute PrintTickets 1403 and 1405).

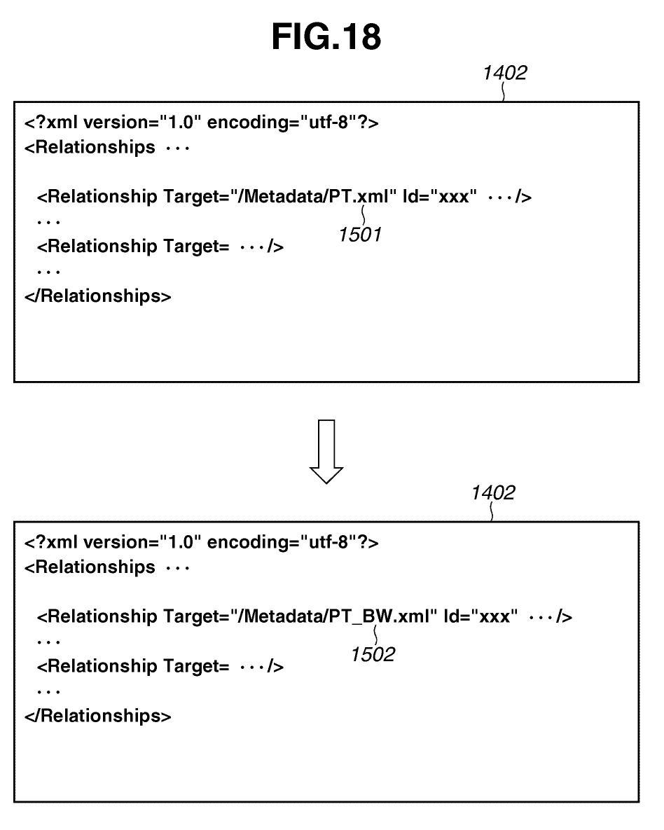

FIG. 18 illustrates an example of a content of the relationship file 1402 before and after the Target attribute of the Relationship element is changed. As illustrated in FIG. 16A, the relationship file 1402 is stored in the XPS document 1401.

Referring to FIG. 18, the document control unit 402 rewrites the Target attribute value of the Relationship element in the relationship file 1402 from “PT.xml” 1501 to “PT_BW.xml” 1502. If the printing apparatus 103 prints the XPS document 1401 after the Target attribute value is rewritten, “PT_BW.xml” is used as the print setting of the job.

A case where the substitute PrintTickets 1403 and 1405 are added to the XPS document 1401 and the user instructs the printing apparatus 103 to perform pull printing will be described more specifically. A user can instruct a printing apparatus 103 other than the printer A to perform pull printing.

The document control unit 402 of the print server 102 identifies the XPS document and the PrintTickets (substitute PrintTickets 1403 and 1405) to be transmitted to the printing apparatus 103 based on the document name of the print document and the user name.

The document control unit 402 then rewrites the Target attribute of the Relationship element in the relationship file 1402 of the identified XPS document to the name of the identified PrintTicket. The network communication unit 401 transmits the XPS document including the PrintTicket to the printing apparatus 103. In the present exemplary embodiment, a third acquisition unit of a printing apparatus is realized by the printing apparatus 103 receiving the XPS document 1401 in step S1313.

As described above, according to the present exemplary embodiment, if a print setting is changed by a user when printing a print document, the printing apparatus 103 changes the print setting. The printing apparatus 103 then transmits to the print server 102 the content of the changed print setting, the name of the user who changed the setting, and the document name of the XPS document 1401 selected by the user. The printing apparatus 103 restores the changed print setting to the former print setting after performing the above-described process.

The print server 102 adds the substitute PrintTickets 1403 and 1405 to the XPS document 1401 selected by the user, based on the content of the changed print setting. Further, the print server 102 stores in the XPS document 1401 the map information 1404, which associates the added substitute PrintTickets 1403 and 1405 with the users. Therefore, in a case where the user changes the setting of the printer apparatus 103, the changed content is effective only for the user and is prevented from affecting other users.

The present exemplary embodiment describes an example in which a print setting of a job is changed. However, a process of the present exemplary embodiment can be applied to a case where a print setting of a document or a page is changed. Further, in the present exemplary embodiment, the map information 1404 is stored in the XPS document 1401. However, the map information 1404 can be stored outside the XPS document 1401, such as in the document storage unit 403 of the print server 102.

When a user registers a print document in the print server 102 (or a file server), there is a case where the user can make a print setting to a print document by selecting from several frequently used print settings provided for the user. In such a case, the same print setting is made to a plurality of print documents.

In a third exemplary embodiment of the present invention, when the same print setting is made to a plurality of print documents as described above, a result of comparison between the print setting of one of the print documents and the print capability of a printing apparatus is reflected in the other print documents of the same print setting. The present exemplary embodiment is thus different from the first and second exemplary embodiments in a part of the process performed when the print document information (print setting information, refer to FIG. 4B) stored in the document storage unit 403 is updated. Therefore, portions in the third exemplary embodiment that are similar to the first and second exemplary embodiment will be assigned the same reference numerals as in FIGS. 1 to 18, and a detailed description is not repeated.

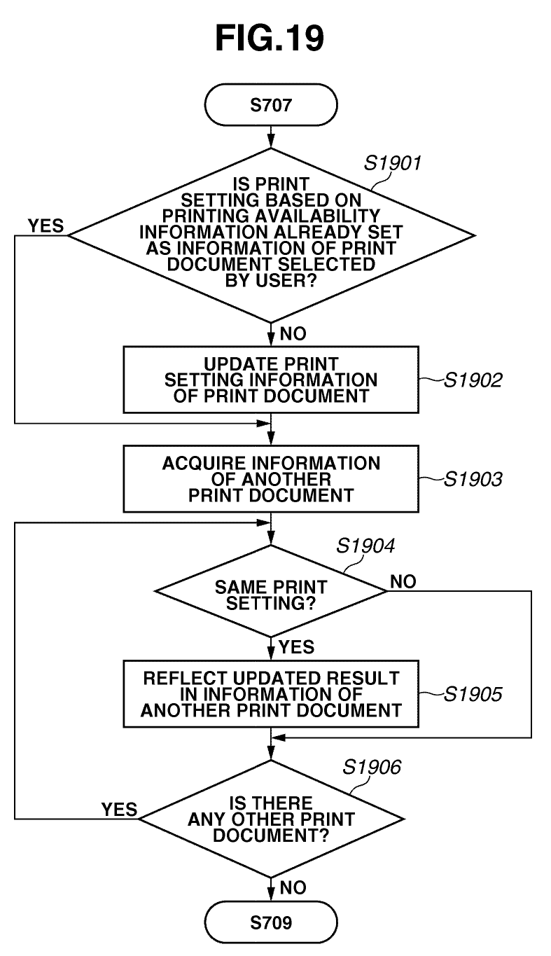

FIG. 19 is a flowchart illustrating an example of a process performed by the print server 102 to update print document information (print setting information). The process illustrated in FIG. 19 is performed in place of step S708 in the flowchart illustrated in FIG. 7.

In step S1901, the document control unit 402 determines whether the print setting information that corresponds to the printing availability information received in step S707 in the flowchart illustrated in FIG. 7 is already set as information of the print document selected by the user. If the print setting information is already set to the information about the print document selected by the user (YES in step S1901), the processing skips step S1902 and proceeds to step S1903.

On the other hand, if the print setting information that corresponds to the printing availability information received in step S707 is not set to the information of the print document selected by the user (NO in step S1901), the processing proceeds to step S1902. In step S1902, the document control unit 402 updates the information of the print document selected by the user stored in the document storage unit 403, according to a content of the printing availability information. The processing then proceeds to step S1903.

In step S1903, the document control unit 402 acquires information of another print document stored in the document storage unit 403.

In step S1904, the document control unit 402 determines whether the print setting compared to the print capability is the same as the print setting of the print document acquired in step S1903. If the print settings are the same (YES in step S1904), the processing proceeds to step S1905.

In step S1905, the document control unit 402 reflects the print document information (print setting information) acquired in step S707 illustrated in FIG. 7 in the print document information acquired in step S1903. As described above, according to the present exemplary embodiment, a determination unit is realized by performing the process of step S1904, and a reflection unit is realized by performing the process of step S1905.

In step S1906, the document control unit 402 determines whether there is any other print document in the document storage unit 403 to which the processes of steps S1904 and S1905 are not performed. The steps S1904 and S1905 are then repeated until all print documents in the document storage unit 403 are processed.

As described above, according to the present exemplary embodiment, when the print document information (print setting information) is updated, the updated result is reflected in the print document information (print setting information) of other print documents having the same print setting as the print document. As a result, print document information (print setting information) can be updated more efficiently.

In the first exemplary embodiment, when a pull printing is performed on a print document whose print setting is already compared to the print capability of the printing apparatus, the comparison is repeated.

In a fourth exemplary embodiment, a repetition of comparison between the print setting and the print capability is not repeated when it is already set in the print setting information that the printing apparatus 103 to perform pull printing can print. The present exemplary embodiment is thus different from the first, second, and third exemplary embodiments in the process of comparing the print setting of a document selected by a user with the print capability of the printing apparatus 103. Therefore, portions in the fourth exemplary embodiment that are similar to the first, second, and third exemplary embodiment will be assigned the same reference numerals as in FIGS. 1 to 19, and a detailed description is not repeated.

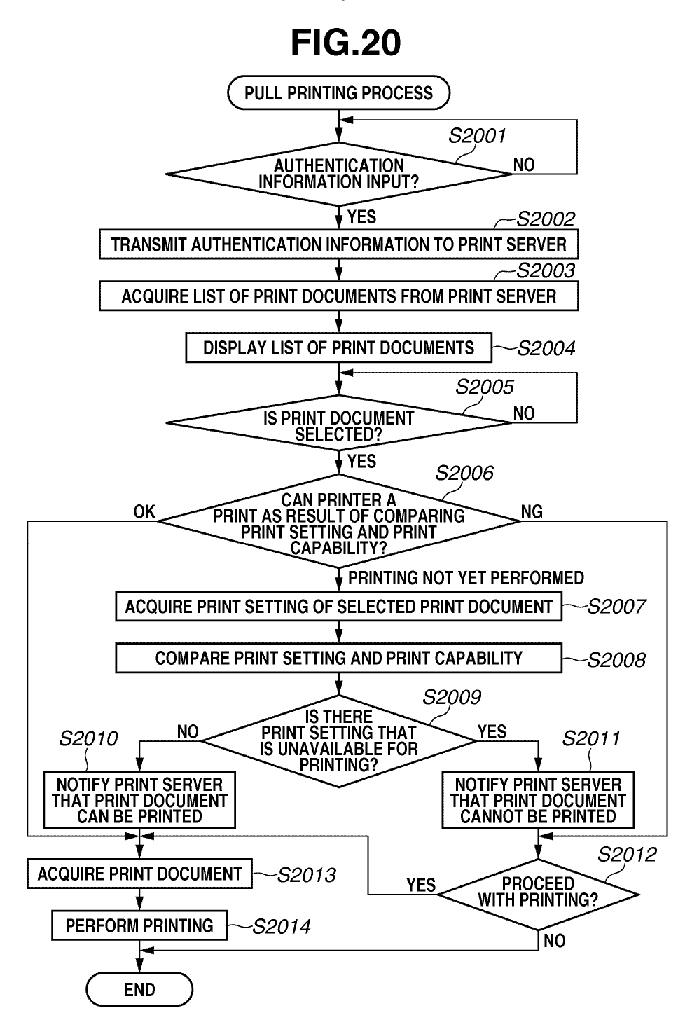

An example of a process performed by the printing apparatus 103 will be described below with reference to a flowchart illustrated in FIG. 20.

In step S2001, the authentication control unit 305 of the printing apparatus 103 stands by until a user inputs authentication information (ID) via the panel 303 of the printing apparatus 103 (hereinafter, the printing apparatus 103 will be referred to as printer A as necessary to differentiate it from other printing apparatuses 103).

When the user inputs the authentication information (YES in step S2001), the processing proceeds to step S2002. In step S2002, the network communication unit 302 transmits the input authentication information to the print server 102.

In step S2003, if the user authentication in the print server 102 is successful, the list acquisition unit 311 acquires from the print server 102 a list of print documents that can be printed by the user who has been authenticated. As described in the first exemplary embodiment, the printing apparatus 103 can also perform the user authentication process.

In step S2004, the panel control unit 304 of the printing apparatus 103 acquires the list of print documents that can be printed by the user and displays the list on the panel 303. The panel control unit 304 displays the operation screen 801 (list) illustrated in FIG. 8C on the panel 303.

In step S2005, the panel control unit 304 stands by until the user selects the print document to be printed. In a case where the user selects the print document to be printed (YES in step S2005), the processing proceeds to step S2006.

In step S2006, the print capability comparison unit 312 determines the results of the past comparison between the print setting of the print document selected by the user and the print capability of the printer A. As described above, in the present exemplary embodiment, an example of a second determination unit is realized by performing the process of step S2006.

In step S2006, if the print setting of the print document selected by the user has already been compared with the print capability of the printer A, and if it is determined that the print document can be printed by the printer A (OK in step S2006), the processing proceeds to step S2013.

In step S2013, the print data acquisition unit 307 requests the print server 102 to transmit the print document data (print data).

In step S2014, the network communication unit 302 of the printing apparatus 103 receives the data of the print document selected by the user according to the request. The image forming apparatus 309 then performs printing based on the data. The processing then ends. As described above, in the present exemplary embodiment, an example of a third acquisition unit is realized by performing the process of step S2013, and an example of a printing unit of a printing apparatus is realized by performing the process of step S2014.

On the other hand, in step S2006, if the print setting of the print document selected by the user has already been compared with the print capability of the printer A, and if it is determined that the print document cannot be printed by printer A (NG in step S2006), the processing proceeds to step S2012.

In step S2012, the panel control unit 304 displays a confirmation screen (not illustrated) on the panel 303. The print data acquisition unit 307 then determines whether to continue printing based on a user operation on the confirmation screen. If printing is not to be continued (NO in step S2012), the processing ends. On the other hand, if printing is to be continued (YES in step S2012), the processing proceeds to step S2013. In step S2013, the print data acquisition unit 307 requests the print server 102 to transmit the print document data (print data) as described above.

Further, in step S2006, if the print setting of the print document selected by the user is not yet compared with the print capability of the printer A (PRINTING NOT YET PERFORMED in step S2006), processes similar to steps S608 to S613 in the flowchart illustrated in FIG. 6 described in the first exemplary embodiment are performed.

More specifically, in step S2007, the print setting acquisition unit 306 acquires the print setting of the print document selected by the user from the print server 102. In step S2008, the print capability comparison unit 312 compares the acquired print setting with the print capability information of the printer A itself.

In step S2009, the print capability comparison unit 312 determines whether there is a setting in the print setting of the print document selected by the user that is unavailable for printing by the printer A.

In steps S2010 and S2011, the print capability comparison result processing unit 313 notifies the print server 102 via the network communication unit 302 of printing availability information indicating the result of the determination. In a case where there is no print setting that is unavailable for printing by the printer A in the print document selected by the user (NO in step S2009), printing is performed in steps S2013 and S2014. On the other hand, in a case where there is a print setting that is unavailable for printing by the printer A (YES in step S2009), printing is performed in steps S2011 to S2014 only when there is an instruction from the user (YES in step S2012).

As described above, according to the present exemplary embodiment, an example of a determination unit is realized by performing the process of step S2009, and an example of an output unit of a printing apparatus is realized by performing the processes of steps S2010 and S2011.

According to the present exemplary embodiment, if the print setting of the print document selected by the user is already compared with the print capability of the printing apparatus which is instructed to perform pull printing, the comparison result is used in performing pull printing. As a result, unnecessary comparison can be avoided.

Each unit included in the printing apparatus and the document management apparatus, and each step included in the print control method and the document management method according to the exemplary embodiments of the present invention can be realized by executing a program stored in a RAM or a ROM of a computer. In this case, the program itself and a storage medium that stores the program constitute the invention.

Further, the present invention can be in a form of a system, and apparatus, a method, a program, or a storage medium. More specifically, the present invention can be applied to a system configured of a plurality of devices, or an apparatus including one device.

The present invention can also be achieved by providing a storage medium which stores software (program code) for implementing functions of the above-described exemplary embodiments (for example, programs that correspond to the flowcharts illustrated in FIGS. 6, 7, 13, 14, 15, 17, 19, and 20) to a system or an apparatus. The program code stored in the storage medium can be read and executed by a computer (a central processing unit (CPU) or a micro-processing unit (MPU)) of the system or the apparatus.

In this case, the software (program code) itself realizes the functions of the above-described exemplary embodiments. The software (program code) itself and the storage medium that stores the software (program code) constitute the present invention.

A computer executable program to implement the above-mentioned exemplary embodiments can take any form readable by computer, for example, an object code, a program executed by an interpreter, or script data to be supplied to an operating system (OS).

The storage medium can be, for example, a floppy disk, a hard disk, a magneto-optical disk, a compact disc-read-only memory (CD-ROM), a CD-recordable (CD-R), a CD-rewritable (CD-RW), a magnetic tape, a nonvolatile memory card, a ROM, or a digital versatile disc (DVD, DVD-ROM, and DVD-R).

Such software (program code) can also be supplied by accessing a web page on the Internet through the browser of a client computer. The software (program code) itself or a compressed file including an auto-install function can be downloaded from the web page onto a hard disk. In addition, the program code can be broken up into a plurality of files, and each file can be downloaded from different web pages. Namely, the present invention can be applied to a World Wide Web (WWW) server that allow numerous users to download the program files so that the functions or processes of the present invention can be realized on their computers.

Furthermore, such software (program code) can be encrypted and stored in a storage medium, such as a CD-ROM, to be distributed to users. A user who meets given conditions can download the key information for decrypting the program from a web page through the Internet. By using the key information, the encrypted program can be executed and installed in a computer to realize the functions of the present invention.

Furthermore, the above-described exemplary embodiments can be realized by executing software (program code) read by a CPU. However, an operating system (OS) or the like working on a computer can also perform a part or the whole of processes according to instructions of the software (program code) and realize functions of the above-described exemplary embodiments.

Furthermore, software (program code) read from a storage medium can be stored in a memory equipped in a function expansion board inserted in a computer or a function expansion unit connected to a computer, and a CPU in the function expansion board or the function expansion unit can execute all or a part of the processing according to the instructions of the software (program code) to realize the functions of the above-described exemplary embodiments.

According to an exemplary embodiment of the present invention, a printing apparatus acquires from a document management apparatus printing availability information about a determination result of whether the printing apparatus can print document data. The acquired printing availability information is displayed together with information about the printing apparatus. As a result, a user can easily determine the printing apparatus that can print the document data before printing, in a case where the document data including a print setting is to be output to the printing apparatus according to a request from the printing apparatus and be printed on the printing apparatus.

Further, according to an exemplary embodiment of the present invention, if a user changes the print setting, the printing apparatus changes the setting, outputs the changed setting to the document management apparatus, and then restores the setting to the former setting. The document management apparatus adds the content of the changed setting to the document data and outputs it to the printing apparatus. The print data thus prints the document data according to the content of the added setting. Therefore, when document data including a print setting is output to a printing apparatus according to a request from the printing apparatus and be printed by the printing apparatus, the document data can be printed using the print setting appropriate to the user without affecting other users.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-031005 filed Feb. 12, 2008, which is hereby incorporated by reference herein in its entirety.

What is claimed is:

1. A printing apparatus comprising:
a first acquisition unit configured to acquire a print setting of document data from a document management apparatus;
a determination unit configured to determine whether the document data can be printed using the print setting acquired by the first acquisition unit;
an output unit configured to output information about a result determined by the determination unit to the document management apparatus;
a second acquisition unit configured to acquire, from the document management apparatus, printing availability determination information about a determined result as to whether document data can be printed with the printing apparatus;
a display unit configured to display the printing availability determination information acquired by the second acquisition unit and printing apparatus information on a display apparatus;
a third acquisition unit configured to acquire document data designated by a user from the document management apparatus by requesting the document management apparatus to transmit the document data; and
a printing unit configured to print the document data acquired by the third acquisition unit.

2. The printing apparatus according to claim 1, further comprising:
a first changing unit configured to change the print setting in response to an operation by a user after the determination unit determines that the print data cannot be printed using the print setting acquired by the first acquisition unit;
a second output unit configured to output to the document management apparatus setting information about the print setting changed by the first changing unit, user information about the user, and document information about the document data designated by the user; and
a second changing unit configured to restore the print setting changed by the first changing unit to a former setting after the second output unit outputs the setting information changed by the first changing unit, the user information, and the document information,
wherein the third acquisition unit acquires from the document management apparatus document data to which a content of setting information output by the second output unit is added, and
wherein the printing unit prints the document data based on the setting information added to the document data.

3. The printing apparatus according to claim 1, further comprising:
a storage unit configured to store the printing availability determination information acquired by the second acquisition unit; and
a second determination unit configured to determine whether document data designated by the user can be printed based on the printing availability determination information stored in the storage unit;
wherein the third acquisition unit acquires the document data from the document management apparatus when the second determination unit determines that the document data designated by the user can be printed.

4. A document management apparatus comprising:
a first output unit configured to output a print setting of document data to a printing apparatus;
an acquisition unit configured to acquire from the printing apparatus information about whether the document data can be printed using the print setting output from the first output unit;
an updating unit configured to update information about a print setting of the document data using the information acquired by the acquisition unit; and
a second output unit configured to output document data requested by the printing apparatus to the printing apparatus,
wherein the second output unit outputs the document data, in which information about the print setting is updated, to the printing apparatus when the information about the print setting of the document data requested by the printing apparatus is updated by the updating unit.

5. The document management apparatus according to claim 4, further comprising:
a second acquisition unit configured to acquire from the printing apparatus setting information about a print setting, user information about a user who has instructed the setting, and document information about document data designated by the user; and
an adding unit configured to add a content of the setting information to the document data identified by the document information and the user information,
wherein the second output unit outputs to the printing apparatus the document data to which a content of the setting information is added by the adding unit.

6. The document management apparatus according to claim 4, further comprising:
a determination unit configured to determine whether there is document data whose print setting is similar to a print setting of document data whose information is updated by the updating unit; and
a reflection unit configured to reflect a content of information acquired by the acquisition unit in the document data when the determination unit determines that the print setting of the document data is similar to the print setting of the document data whose information is updated by the updating unit.

7. A print control method comprising:
acquiring a print setting of document data from a document management apparatus;
determining whether the document data can be printed using the acquired print setting;
outputting information about the determined result to the document management apparatus;
acquiring printing availability determination information about a determined result as to whether document data can be printed with a printing apparatus from the document management apparatus;
displaying the acquired printing availability determination information and printing apparatus information on a display apparatus;
acquiring document data designated by a user from the document management apparatus by requesting the document management apparatus to transmit the document data; and
printing the acquired document data.

8. A document management method comprising:
outputting a print setting of document data to a printing apparatus;
acquiring from the printing apparatus information about whether the document data can be printed using the output print setting;
updating information about a print setting of the document data using the acquired information;
outputting the document data requested by the printing apparatus to the printing apparatus; and
outputting the document data in which print setting information is updated to the printing apparatus when the print setting information of the document data requested by the printing apparatus is updated.

9. A computer-readable storage medium storing a computer program that causes a computer to execute a print control method comprising:
acquiring a print setting of document data from a document management apparatus;
determining whether the document data can be printed using the acquired print setting;
outputting information about the determined result to the document management apparatus;
acquiring printing availability determination information about a determined result as to whether document data can be printed with a printing apparatus from the document management apparatus;
displaying the acquired printing availability determination information and printing apparatus information on a display apparatus;
acquiring document data designated by a user from the document management apparatus by requesting the document management apparatus to transmit the document data; and
printing the acquired document data.

10. A computer-readable storage medium storing a computer program that causes a computer to execute a document management method comprising:
outputting a print setting of document data to a printing apparatus;
acquiring from the printing apparatus information about whether the document data can be printed using the output print setting;
updating information about a print setting of the document data using the acquired information;
outputting document data requested by the printing apparatus to the printing apparatus; and
outputting document data in which a print setting information is updated to the printing apparatus when the print setting information of document data requested by the printing apparatus is updated.
